(19) United States
(12) Patent Application Publication
(10) Pub. No.: US 2026/0045133 A1
(43) Pub. Date: Feb. 12, 2026

(54) IMPROVED STRUCTURE OF COIN CHANGER

(71) Applicant: INTERNATIONAL CURRENCY TECHNOLOGIES CORPORATION, Taipei (TW)

(72) Inventors: Chia-Min CHANG, Taipei (TW); Hung-Yi CHANG, Taipei (TW); Dong-Ying YANG, Taipei (TW)

(21) Appl. No.: 18/796,538

(22) Filed: Aug. 7, 2024

(51) Int. Cl. G07D 1/02; G07D 3/02; G07D 5/00; G07D 9/06

(52) U.S. Cl. CPC G07D 1/02; G07D 3/02; G07D 5/00; G07D 9/06; G07D 2201/00

(57) ABSTRACT

A coin changer includes a coin-dispensing unit with coin outlets located below coin storage tubes of a coin distribution unit, and sensors and a rotating disk of a dial device set in each coin outlet, and a driving device for driving each rotating disk, so that the swing rod on each rotating disk drives shifting members to rotate. Each shifting member has an arm with a push block for the swing rod to push, and a coin shifting rod. A positioning portion on one side of an elastic coin baffle is fixed in each coin outlet, and has limit rods, two sliding spring arms facing the coin outlet, and a slot for the coin shifting rod to slide in and out, so that each coin shifting rod can push the sliding spring arms to swing, thereby controlling the coin dispensing of each coin storage tube.

### BACKGROUND OF THE INVENTION

### 1. Field of the Invention

The present invention provides an improved structure of coin changer, in particular a coin changer structure capable of monitoring the rotational position of a rotating disk at the coin outlet to control coin dispensing, which is provided with a coin distribution unit and a coin-dispensing unit in the accommodation space of the main body. The purpose of controlling the coin distribution unit to dispense coins from the coin outlet can be achieved by using the sensor and the sensed component to detect the rotational position of the rotating disk through the dial device of the coin-dispensing unit.

### 2. Description of the Related Art

Today's technology is developing rapidly and innovating constantly, which has a significant impact on people's lives and work. It also provides people with a lot of comfort and convenience in their daily clothing, food, housing, transportation and entertainment. It also emphasizes convenience, timeliness and time saving. That is, there are many automated electronic devices that can provide people with what they need in their daily lives. Common electronic machines such as automated vending machines, ticket machines, cash machines, coin exchange machines, cash registers, electronic game machines or public information machines (KISOK) can facilitate related shopping, recharging or transactions by coin insertion. Due to the convenience of various electronic devices, more and more types of electronic devices are developed and applied.

Furthermore, various electronic devices commonly seen on the market can be operated and traded by coin insertion, without the need for human assistance, thus achieving the goal of unmanned management and sales of goods. However, because the prices of goods, services or transactions provided by various electronic devices are not the same, in addition to paper money, there are also different denominations of a variety of coins available for selection when using various electronic devices. In order to accept and withdraw various denominations of coins, the coin receiving devices in the electronic devices will be equipped with identification modules, coin separation modules, etc. to identify the authenticity and value of the inserted coins, and then sort the different coins into different storage spaces for storage. For the operation of various electronic devices, the inserted coins can be stored, changed, exchanged or returned for recycling, making the operation and application of various electronic devices more convenient.

However, when the coin receiving devices installed in various electronic devices are performing operations such as dispensing, returning or exchanging coins, they will output the required coins to the coin outlet of the electronic device according to the signal instructions of the electronic device operation. When a general coin receiving device is dispensing coins, the stacked coins in the coin storage tube storing different denominations of coins may interfere with each other due to friction and static electricity. The coin dispensing system in the coin receiving device cannot effectively detect the coins, and it is easy to eject two or more coins at a time, resulting in the losses of change, exchange or return of coins. It will not only easily lead to a higher probability of failure of the coin receiver, but also cause losses to the operator.

Therefore, how to solve the problem and trouble that the coin receiving device of the electronic device is prone to errors when making change, exchanging or dispensing coins, and how to solve the trouble and inconvenience that easily causes machine failure and losses to the operator is the direction that the relevant manufacturers engaged in this industry are eager to study and improve.

### SUMMARY OF THE INVENTION

Therefore, in view of the above problems and deficiencies, the inventor collected relevant information, evaluated and considered various aspects, and used his many years of experience in this industry to continuously create, research and improve, and finally designed the invention patent of this improved structure of coin changer.

The main object of the present invention is that the improved structure of coin changer comprises a main body, a coin distribution unit and a coin-dispensing unit. The main body comprises an accommodation space inside for accommodating the coin distribution unit and the coin-dispensing unit.

The coin-dispensing unit has a base set below the channels inside the plurality of coin storage tubes of the coin distribution unit, so that the two adjacent coin outlets of the base can correspond to the channels. Each coin outlet is equipped with at least one sensor and a dial device. A transmission device is set between the rotating disk of each dial device and one respective driving device. The rotating disk can be driven by a driving device to rotate clockwise or counterclockwise. At least one swing rod on each rotating disk can drive shifting members to rotate in a forward or reverse direction. Each shifting member has an arm connected to the shaft on one side thereof and provided with a push block for the swing rod to push, and there is a coin shifting rod on the other side thereof. An elastic coin baffle is provided corresponding to each shifting member. The positioning portion of each elastic coin baffle is fixed on the wall of the coin outlet. There are limit rods on the other side of the two elastic coin baffles relative to the positioning portion. The two sliding spring arms on one side of the positioning portion face the coin outlet, so that the preset coins fall into the two sliding spring arms and are detected by the at least one sensor until they are positioned. A slot is formed between the two sliding spring arms of each elastic coin baffle for each coin shifting rod to slide in and out, so that each coin shifting rod can push the two sliding spring arms to swing outwards. It can also effectively monitor the coin outlets of the coin-dispensing unit to dispense coins, so as to achieve the purpose of controlling the coin dispensing of the coin-dispensing unit.

Another object of the present invention is that a coin sorting unit is set on the plurality of coin storage tubes of the coin distribution unit, which can guide various preset coins to fall into each channel of each coin storage tube, an identification unit is located above the coin sorting unit to identify the authenticity and value of preset coins, and the coin distribution unit has a coin slot located on the top of the main body.

Still another object of the present invention is that each sensor of the coin-dispensing unit set at each coin outlet can be a Hall sensor or other types of detection elements, and each sensor may be equipped with a sensed component, which is a permanent magnet made of neodymium iron boron material, to confirm the rotational position or angle of the rotating disk at the coin outlet.

Still another object of the present invention is that each driving device of the coin-dispensing unit is a step motor for driving at least one rotating disk to rotate clockwise or counterclockwise, and the coin-dispensing unit further comprises a transmission device assembled between each driving device and each rotating disk to transmit power, and the transmission device can be composed of a gear set, a gear and a rack, a pulley and a belt, or a sprocket and a chain.

### BRIEF DESCRIPTION OF THE DRAWINGS

FIG. 1 is a three-dimensional external view of the present invention.

FIG. 2 is a three-dimensional exploded view of the present invention.

FIG. 3 is a three-dimensional exploded view of the present invention from another viewing angle.

FIG. 4 is a three-dimensional exploded view of the coin-dispensing unit of the present invention.

FIG. 5 is a three-dimensional exploded view of the coin-dispensing unit of the present invention from another viewing angle.

FIG. 6 is a top view of a preferred embodiment of the coin-dispensing unit of the present invention.

FIG. 7 is a top view of another embodiment of the coin-dispensing unit of the present invention.

FIG. 8 is a top view of the shifting member of the present invention before operation.

FIG. 9 is a top view of the shifting member of the present invention during operation.

### DETAILED DESCRIPTION OF THE PREFERRED EMBODIMENT

In order to achieve the above-mentioned purpose and effect, the technical means adopted in the present invention, its structure, and the method of implementation, etc. are hereby drawn in detail to illustrate the features and functions of the preferred embodiments of the present invention as follows, so as to facilitate a complete understanding.

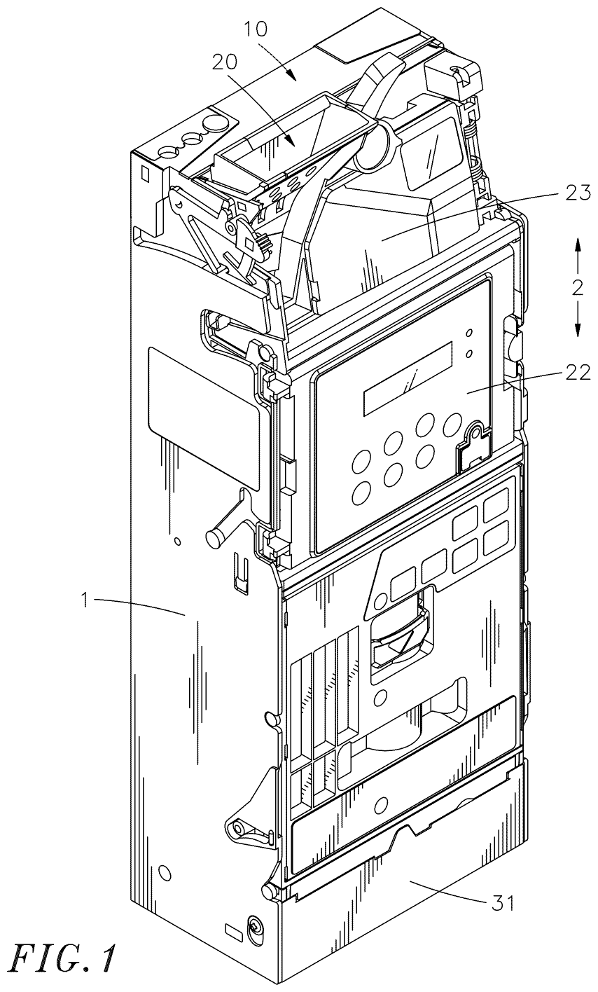

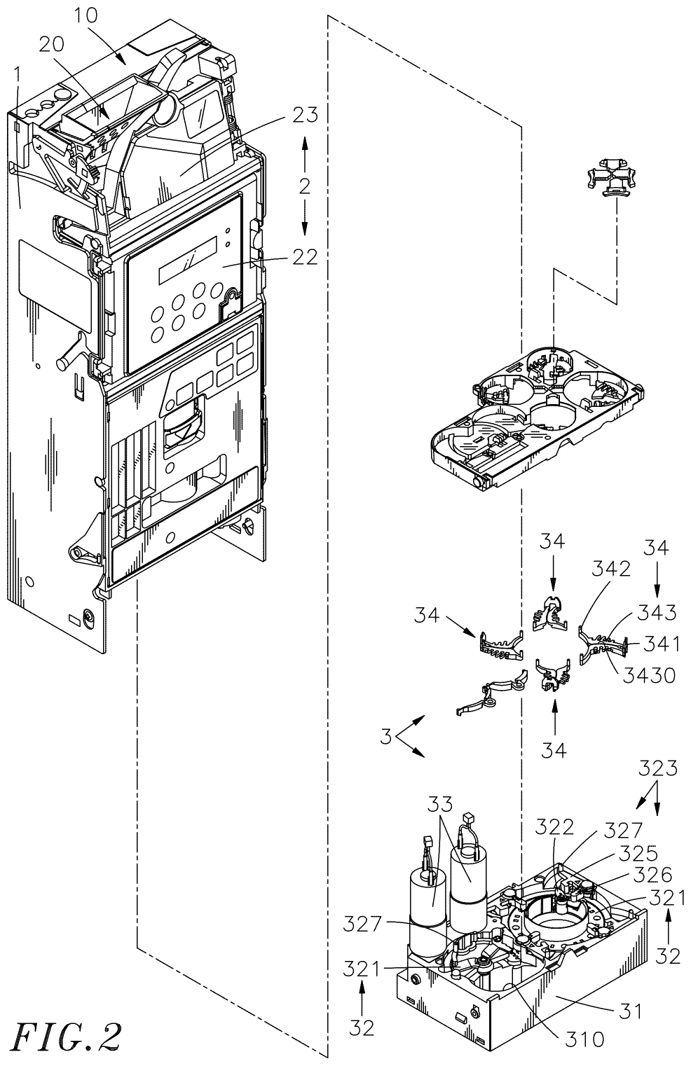

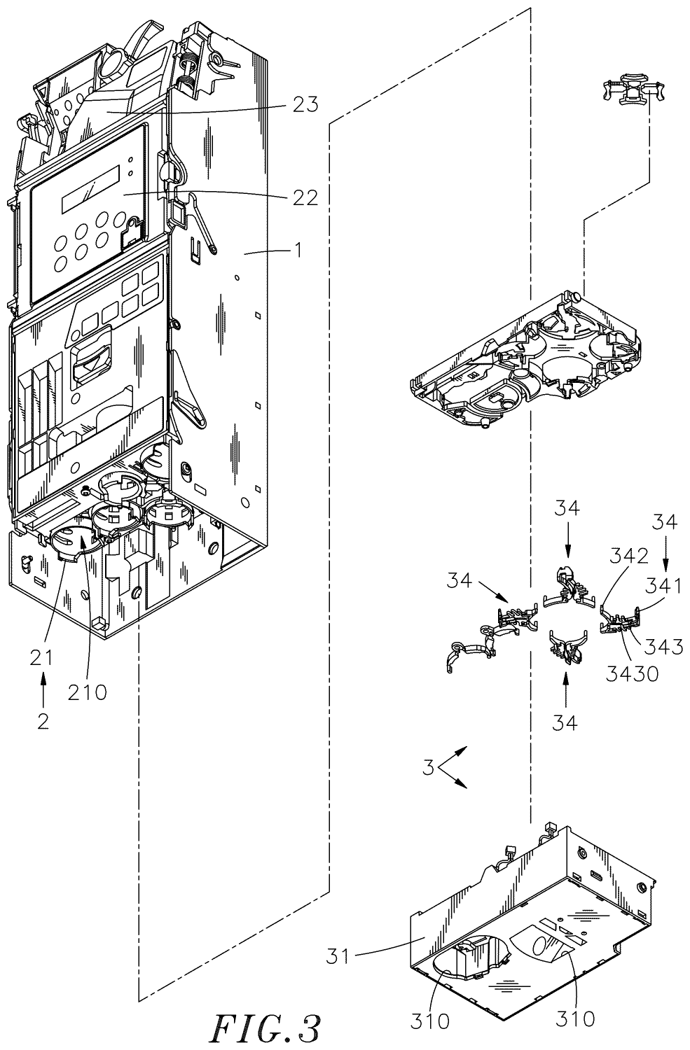

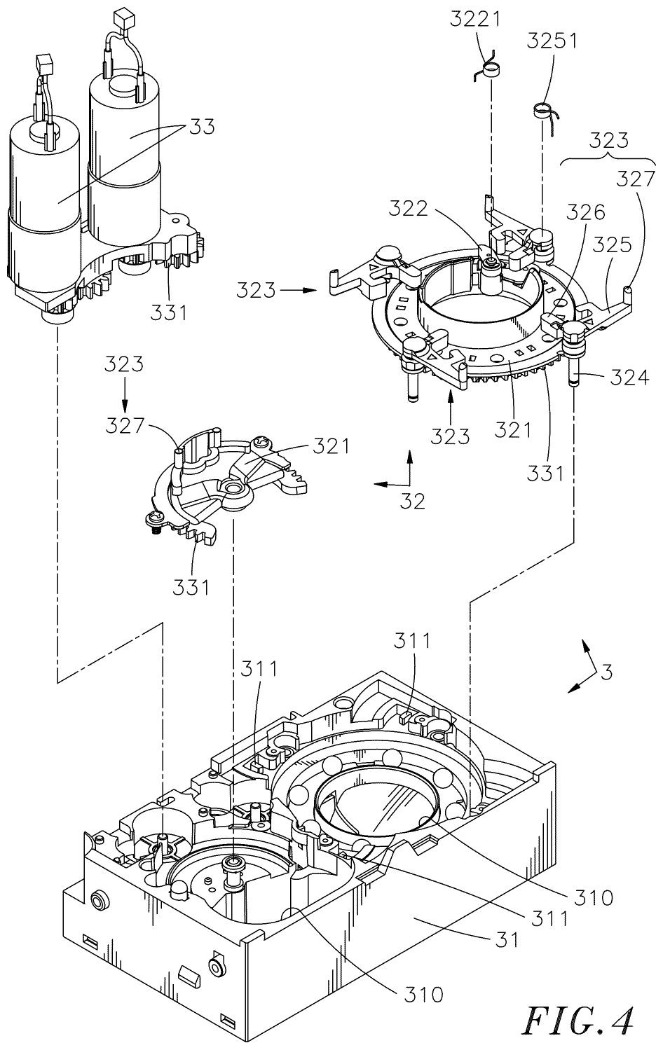

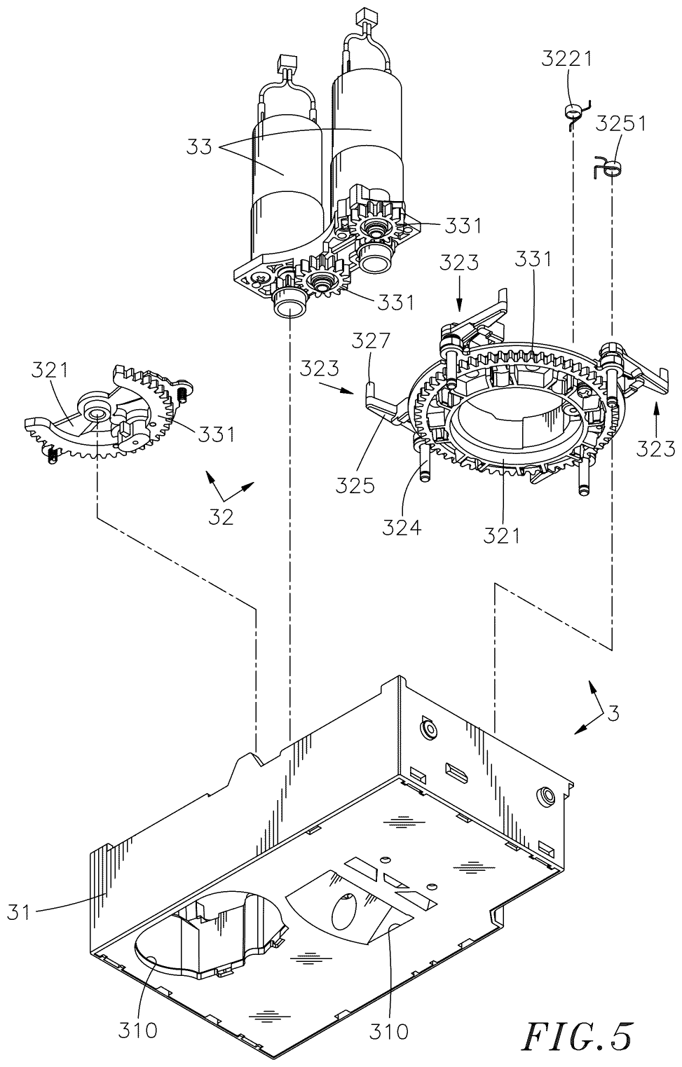

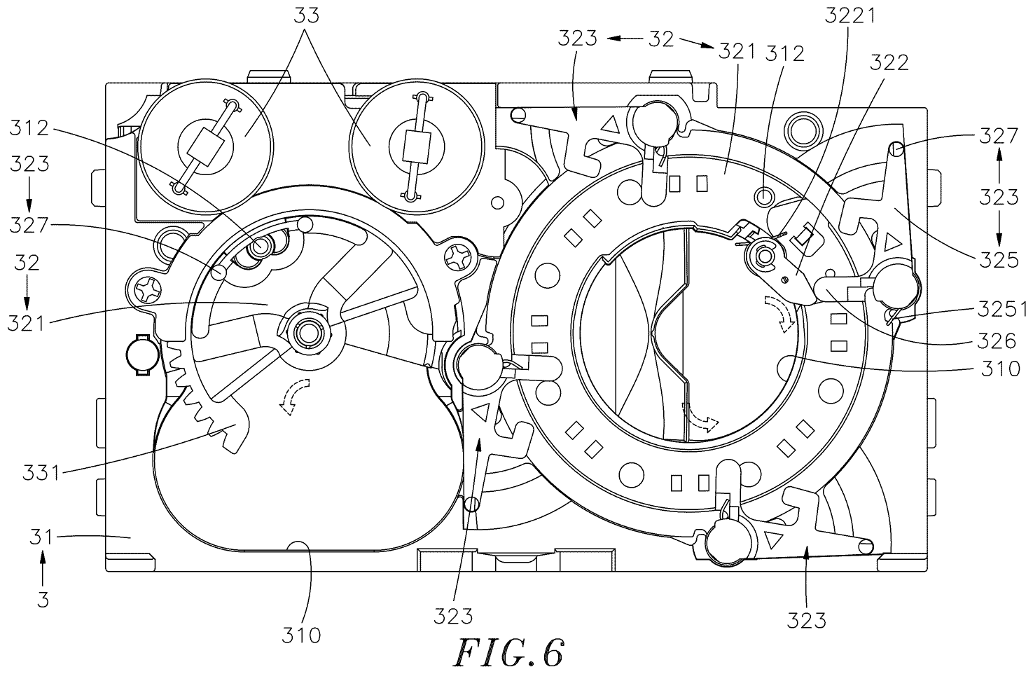

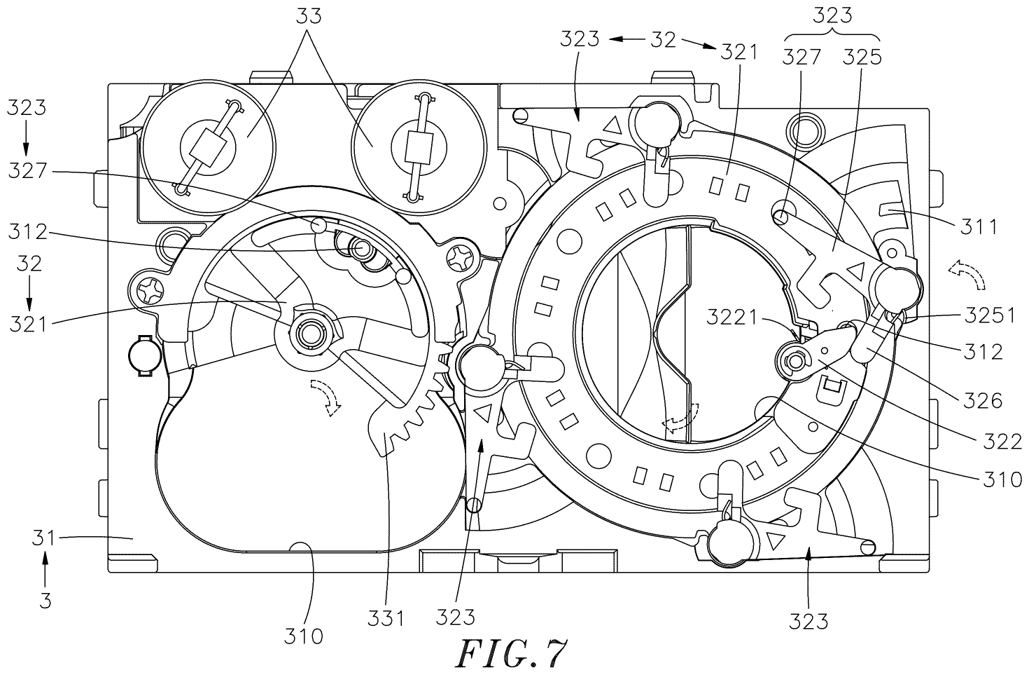

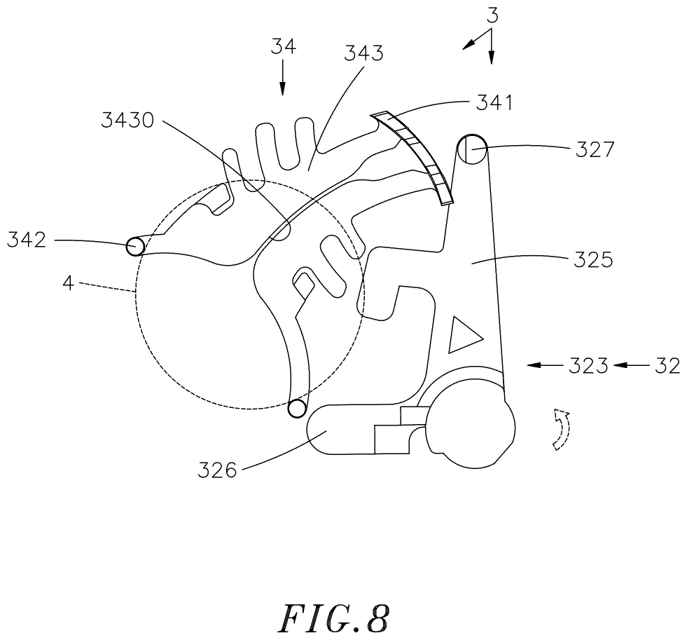

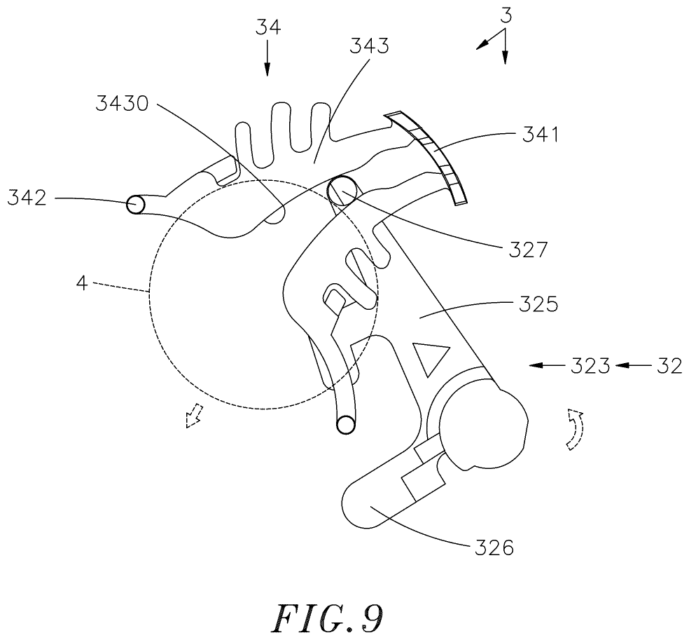

Please refer to FIGS. 1-10, the improved structure of coin changer of the present invention comprises a main body 1, a coin distribution unit 2 and a coin-dispensing unit 3.

The main body 1 comprises an accommodation space 10 therein for accommodating the coin distribution unit 2 and the coin-dispensing unit 3.

The coin distribution unit 2 is provided with a plurality of coin storage tubes 21 located inside the accommodation space 10, and channels 210 are formed inside the plurality of coin storage tubes 21 respectively, so that preset coins 4 can be placed into the channels 210 inside the coin storage tubes 21 according to the denomination and size.

The coin-dispensing unit 3 comprises a base 31 located below the plurality of coin storage tubes 21 in the accommodation space 10, and the base 31 is provided with two adjacent coin outlets 310 respectively corresponding to each channel 210 located in the plurality of coin storage tubes 21. At each coin outlet 310, at least one sensor 311 and a dial device 32 are provided. The at least one sensor 311 can be used to detect the location and quantity of the preset coins 4 dropped into each coin outlet 310. Each dial device 32 is provided with a rotating disk 321 located above the at least one sensor 311 at each coin outlet 310. The coin-dispensing unit 3 further comprises two driving devices 33 for driving the rotating disks 321 of the dial devices 32 to rotate in a forward or reverse direction at each coin outlet 310. A transmission device 331 is assembled between each driving device 33 and each rotating disk 321 to transmit power. Each rotating disk 321 is provided with at least one swing rod 322, and a plurality of shifting members 323 driven by each swing rod 322 for forward or reverse rotation. Each shifting member 323 comprises a shaft 324, an arm 325 connected to the shaft 324. Each arm 325 has a push block 326 on one side thereof for the swing rod 322 to push, and a vertically protruding coin shifting rod 327 on the other side thereof. An elastic coin baffle 34 is provided relative to each shifting member 323. Each elastic coin baffle 34 comprises a positioning portion 341 for fixing on the wall surface of the coin outlet 310, two vertically protruding limit rods 342 is provided on one side of the elastic coin baffle 34 relative to the positioning portion 341, two sliding spring arms 343 facing the coin outlet 310 is provided on an opposite side of the elastic coin baffle 34 relative to the positioning portion 341 for the preset coins 4 to be allowed to fall into the two sliding spring arms 343 and be detected by the at least one sensor 311 until they are positioned, a slot 3430 formed between the two sliding spring arms 343 of each elastic coin baffle 34 for the coin shifting rod 327 to slide in and out along the slot 3430 between the two sliding spring arms 343, so that each coin shifting rod 327 can push each two sliding spring arms 343 to swing toward the relative outward sides.

The main body 1 of the present invention can be assembled in various electronic machines such as automatic vending machines, ticket machines, cash machines, coin exchange machines, cash registers, electronic game machines or public information machines (KISOK), so as to facilitate related shopping, recharging or electronic machine transactions by coin insertion.

The coin distribution unit 2 of the present invention further comprises a coin sorting unit 22 above the plurality of coin storage tubes 21, which can guide various preset coins 4 to fall into the channels 210 corresponding to the coin storage tubes 21, an identification unit 23 located above the coin sorting unit 22 to identify the authenticity, value and size of the preset coins 4, and a coin slot 20 located at the top of the main body 1.

Furthermore, each sensor 311 provided by the coin-dispensing unit 3 of the present invention at each coin outlet 310 of the base 31 can be a Hall sensor or other types of detection elements, and the Hall sensor is a preferred implementation element. A sensed component 312 is provided with the at least one sensor 311, and the preferred implementation element of the sensed component 312 is a permanent magnet made of neodymium iron boron material to confirm the rotational position or angle of the rotating disk 321 at the coin outlet 310. When the sensed component 312 is located between two adjacent sensors 311, the sensor 311 which is closer to the sensed component 312 detects it and then repositions itself closer to the sensed component 312.

Each driving device 33 of the coin-dispensing unit 3 used to drive the at least one rotating disk 321 can be a step motor for driving the rotating disk 321 to rotate clockwise or counterclockwise. The transmission device 331 assembled between each driving device 33 and each rotating disk 321 of the coin-dispensing unit 3 for transmitting power can be composed of a gear set, a gear and a rack, a pulley and a belt, or a sprocket and a chain.

Please refer to FIGS. 1 to 9, when the improved structure of coin changer of the present invention is used in actual applications, preset coins 4 are inserted through the coin slot 20, so that the preset coins 4 can be identified the value and authenticity by the identification unit 23 of the coin distribution unit 2. Then, the coin sorting unit 22 sorts the preset coins 4 into the channels 210 of the corresponding coin storage tubes 21 according to the value or size of the preset coins 4. When the coins are to be withdrawn, the built-in system of the main body 1 (not a technical feature of this invention, not described in detail) controls the preset coins 4 in the channel 210 of any coin storage tube 21 of the coin distribution unit 2 to directly drop into the elastic coin baffle 34 corresponding to the corresponding coin outlet 310. Then, the driving device 33 corresponding to the coin outlet 310 drives the rotating disk 321 at the coin outlet 310 to rotate in a forward (clockwise) or reverse (counterclockwise) direction through the transmission device 331, and the sensor 311 at the coin outlet 310 detects the quantity, size and position of the preset coins 4, thereby preventing two or more than two preset coins 4 from being released at one time. At the same time, the rotating disk 321 of the dial device 32 is used to rotate the swing rod 322 (which can be clockwise) to push the push block 326 on one side of the shifting member 323 to rotate the arm 325, so that the coin shifting rod 327 on the other side of the arm 325 moves toward the slot 3430 between the two sliding spring arms 343 of the elastic coin baffle 34 to push the two sliding spring arms 343 to move toward the relative outside and separate, then the preset coins 4 on the elastic coin baffle 34 are separated from the elastic coin baffle 34 and fall out of the coin outlet 310. Thus, the coin outlets 310 of the coin-dispensing unit 3 can be effectively monitored to control the purpose of the coin dispensing of the coin-dispensing unit 3, thereby avoiding dispensing two or more than two preset coins 4 at a time and effectively preventing the occurrence of erroneous coin dispensing.

Furthermore, the swing rod 322 of the dial device 32 of the present invention is provided with a first resetting elastic member 3221 (which may be a spring, a reed or a torsion spring, etc.), and the arm 325 is provided with a second resetting elastic member 3251 (which may be a spring, a reed or a torsion spring, etc.) on one side of the shaft 324. When coins are taken out from the coin outlet 310, one of the driving devices 33 drives the rotating disk 321 at the coin outlet 310 to rotate in the reverse direction (counterclockwise) through the transmission device 331, and the swing rod 322 can be reset by the reset elastic force of the first resetting elastic member 3221, and the second resetting elastic member 3251 also links the arm 325 to reset, so that the coin shifting rod 327 on one side of the arm 325 moves in the opposite direction along the slot 3430 between the two sliding spring arms 343 of the elastic coin baffle 34 and moves outward from the positioning portion 341, and the two sliding spring arms 343 are retracted and returned to the inner side, so that the coin-dispensing unit 3 is restored to the state of waiting for coins dispensing.

However, if the arm 325 is pressed by other preset coins 4 and the second resetting elastic member 3251 cannot link the arm 325 to reset, the swing rod 322 can be linked to the reset elastic force of the first resetting elastic member 3221 during the reset process, and then the swing rod 322 can be used to push the push block 326 and move the arm 325, so that the arm 325 is not pressed by other preset coins 4. Then, the second resetting elastic member 3251 can link the arm 325 to reset, and the coin-dispensing unit 3 can also be restored to the state of waiting for coin dispensing.

The above are merely preferred embodiments of the present invention and are not intended to limit the patent scope of the present invention. Therefore, all simple modifications and equivalent structural changes made by using the contents of the description and drawings of the present invention should be included in the patent scope of the present invention and should be declared.

In summary, the improved structure of coin changer of the present invention can achieve its effect and purpose in practical application. Therefore, this invention is truly a research and development creation with excellent practicality. In order to meet the application requirements for invention patents, an application is filed in accordance with the law. I hope that the review committee will approve this case as soon as possible to protect the inventor's hard work in research and development. If the review committee has any questions, please feel free to write to us for instructions. The inventor will do his best to cooperate and we will be very grateful.

What the invention claimed is:

1. An improved structure of coin changer, comprising a main body, a coin distribution unit and a coin-dispensing unit, wherein:
said main body comprises an accommodation space inside for accommodating said coin distribution unit and said coin-dispensing unit;
said coin distribution unit comprises a plurality of coin storage tubes located inside said accommodation space, each said coin storage tube having a channel formed therein for inserting preset coins;
said coin-dispensing unit comprises a base located at a bottom side of the plurality of said coin storage tubes within said accommodation space, two adjacent coin outlets located on said base respectively corresponding to each of said channels of the plurality of said coin storage tubes, a plurality of sensors respectively located in said coin outlets for detecting the position of said preset coins, two dial devices respectively located in said coin outlets, each said dial device comprising a rotating disk provided with at least one sensed component, two driving devices for respectively driving each said dial device and each said rotating disk to rotate in a forward or reverse direction, a transmission device installed between each said driving device and each said rotating disk, at least one swing rod provided on said rotating disk and a plurality of shifting members provided on said rotating disk and driven by said swing rod to rotate in the forward or reverse direction. Each said shifting member comprising a shaft, an arm connected to said shaft, a push block located on one side of said arm for being pushed by said swing rod and a vertically protruding coin shifting rod on an opposite side of said arm, elastic coin baffles being respectively provided corresponding to said shifting members, each said elastic coin baffle comprising a positioning portion for fixing on a wall surface of said coin outlet, two vertically protruding limit rods provided on an opposite side of said elastic coin baffle relative to said positioning portion, two sliding spring arms facing said coin outlet provided on one side of said positioning portion for the preset coins to be allowed to fall into and accommodate said two sliding spring arms, a slot formed between said two sliding spring arms for said coin shifting rod to slide in and out; and
wherein at least one said sensor detects the position of the preset coins and said driving device drives said rotating disk to rotate from the initial position to drive said swing rod to move said push block of said shifting member in a first direction, and said coin shifting rod is linked to push and open said two sliding spring arms, so that the preset coins can fall into said coin outlet, and at least one said sensor then drives said rotating disk to return to the initial position via said driving device according to the relative distance of said sensed component provided in said rotating disk, and said swing rod pushes said push block of said shifting member in a second direction, thereby returning said shifting member to the original position.

2. The improved structure of coin changer as claimed in claim 1, wherein said coin distribution unit further comprises a coin sorting unit provided above the plurality of said coin storage tubes for guiding various said preset coins to fall into said channels of said coin storage tubes respectively, an identification unit provided above said coin sorting unit for identifying the authenticity of the preset coins, and said coin distribution unit is provided above the identification unit; said coin distribution unit further comprises a coin slot located at a top of said main body.

3. The improved structure of coin changer as claimed in claim 1, wherein each said sensor of said coin-dispensing unit provided at each said coin outlet is a Hall sensor, and each said sensor is equipped with one respective said sensed component, which is a permanent magnet made of neodymium iron boron material, to confirm the relative distance of said sensed component in said rotating disk.

4. The improved structure of coin changer as claimed in claim 1, wherein each said driving device of said coin-dispensing unit is a step motor for driving said rotating I disk to rotate clockwise or counterclockwise.

5. The improved structure of coin changer as claimed in claim 1, wherein said coin-dispensing unit further comprises said transmission device assembled between each said driving device and each said rotating disk to transmit power, and each said transmission device is selectively composed of a gear set, a gear and a rack, a pulley and a belt, or a sprocket and a chain.

6. The improved structure of coin changer as claimed in claim 1, wherein each said swing rod of each said dial device of said coin-dispensing unit is provided with a first resetting elastic member, and each said arm is provided with a second resetting clastic member on one side of said shaft, and said first resetting clastic member and said second resetting clastic member are both selectively made of springs, reeds or torsion springs.
